(19) United States
(12) Patent Application Publication
(10) Pub. No.: US 2009/0095696 A1
(43) Pub. Date: Apr. 16, 2009

(54) Shelf storage system with an input station

(75) Inventors: Hartmut Lang, Wernau (DE); Tobias Lang, Plochingen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Modicos Kommissioniersysteme GmbH, Kirchheim/Teck (DE)

(21) Appl. No.: 11/989,261

(22) PCT Filed: Jul. 24, 2006
(86) PCT No.: PCT/EP2006/007276

§ 371 Date: May 18, 2008

(30) Foreign Application Priority Data
Jul. 25, 2005 (DE) 10 2005 035 262.6

(51) Int. Cl. B65G 1/137

(52) U.S. Cl. 211/153; 414/800

(57) ABSTRACT

A shelf storage system having an interim storage shelf which is disposed in a group of primary storage shelves for preliminarily receiving products and a shelf control appliance for receiving products from the interim storage shelf. Products are always stored via the interim storage shelf, with the aid of a transport device. Because of the use of the interim storage shelf, the product can be parked until the shelf control appliance has handled output processing or retrieval of products. Moreover, a second shelf control unit is not required in order to distribute the products in this shelf for the purpose of storage.

### FIELD OF THE INVENTION

The present invention relates generally to shelf storage systems, and more particularly, to a shelf storage system operable for the chaotic storage of products.

### BACKGROUND OF THE INVENTION

Because of the increasing variety of products and the very cramped conditions in pharmacies, miniaturized “high shelf storage systems” with chaotic storage conditions are increasingly being used here. A shelf storage system is known, for example, from DE 101 40 958 A1.

In such shelf storage structure two groups of flat shelves are arranged on either side of an aisle. The shelves form flat, equal-sized supporting surfaces on which the stored products are stored in a chaotic manner. In this system, chaotic means that item placement on the shelves is not separated or arranged by product or active ingredient, but rather that packages with completely different medicines lie next to one another in a row. On the other hand, the storage is systematic insofar as only packages of similar size lie in one row in order to optimize the storage requirements.

The products stored on the shelves are placed on a shelf control appliance via an output edge, i.e., the edge of the shelf that is closest to the aisle with the shelf control appliance. All the output edges of all the shelves on one side of the aisle are situated in a common vertical plane which is an appropriate distance away from the plane of the output edges of the opposite shelves. The shelf control appliance running in front of the output edges can move both along the output edge and in the vertical direction in order to pick up products from each shelf at arbitrary points.

### OBJECTS AND SUMMARY OF THE INVENTION

It is an object of the present invention to provide an improved integrated shelf storage system which optimizes storage space requirements. The novel shelf storage system includes at least one primary storage shelf in one framework, and products can be stored on the shelf in virtual storage rows. The shelf has a longitudinal edge, referred to as an output edge, across which the products are moved when being retrieved from storage. The virtual storage rows are oriented perpendicular to the output edge.

A shelf control appliance moves in front of the output edge in order to take the products down from the shelf and move them to a dispensing station; or the shelf control appliance stores products via this edge in the virtual storage rows. An input station, via which the products to be stored can be input, is integrated into the shelf storage arrangement. At the input station there is a measuring unit with which at least one geometrical dimension of the products is detected in order to determine the virtual storage row with free storage space in which the product to be stored fits on the shelf. This prevents the products in a storage row from differing excessively in their geometric dimensions from one another.

The novel shelf storage system further includes an interim storage shelf on which the products input via the input station are interim-stored. The interim storage shelf has at least one output edge to which the shelf control appliance can move. Thus the shelf control appliance can be used to distribute the products input to the interim storage shelf to free storage spaces in the virtual storage rows of the shelf storage system. On the other hand, products to be stored can be parked during input on the interim storage shelf so that the storing of products does not interfere with retrieving and outputting products from the shelves. Unnecessary waiting times for customers are avoided in this manner, since the retrieval of products has a higher priority. The person inputting the products into the shelf storage system is likewise not hindered by the retrieval process. The coupling of the two processes is achieved by way of the interim storage shelf and thus a collision of the two processes on the level of the shelf control appliance is avoided. Since the shelf control appliance also moves up to the interim storage shelf, it is possible in a similar matter to form virtual storage rows on the interim storage shelf in which products with similar dimensions are interim-stored.

At least one transport device is provided for moving the products from the input station to the corresponding virtual storage row. The product that was moved up to the storage row can be moved into the storage row with the aid of a second transport device. Thus, the interim storage shelf is seemingly divided into a strip-shaped area in which the individual virtual storage rows lie one next to the other and an area along which the products are moved from the input station to the respective storage row.

The two transport devices are advantageously combined into one common transport device that accomplishes both the transfer from the input station to the storage row and the transport within the storage row to the shelf control appliance.

There is a considerable freedom in the novel shelf storage system with respect to the arrangement of the shelves. The shelves can be provided one above another in a framework, while the interim storage shelves are situated opposite the storage shelves, whereby a passageway results in which the shelf control appliance can be moved.

However, the interim storage shelf can also be arranged inside the group of storage shelves if this is more favorable with regard to the space conditions. Another possibility is to arrange two groups of storage shelves on either side of the movement path for the shelf control appliance, with one or the other or both groups each containing an interim storage shelf.

The length of the interim storage shelf is equal to the length of the storage shelves if the input station is appropriately provided in front of the narrow side of the shelf storage system or the interim storage shelf. On the other hand, if the input station does not extend past the narrow side of the shelf storage system, the interim storage shelf is shorter, at least by this part, than the shelf above or below. Finally, depending on how large the buffering volume of the interim storage shelf is selected to be, the remainder of the interim storage shelf can be used as a storage space for storing products. With regard to the space requirement, it is favorable if the interim storage shelf has a depth that is not greater than the depth of the shelves of the respective group.

In order to move the products onto the shelves in a simple manner or to receive them from the interim storage shelf, the shelf control appliance is provided with a transport device that is set up to move product perpendicular to the output edge. Such systems are found in DE 101 40 958 or DE 10 2004 024 478, which are incorporated herein by reference.

Inputting malfunctions are avoided if the input station has an input opening that can be closed by a motor-driven door. The door can be controlled such that it remains closed as long as a storing process is taking place on the interim storage shelf, while it is otherwise always open whenever the storing process is completed.

To avoid errors in storing, a barcode reader can be installed at an input station. The product is detected with the aid of the barcode reader and the dimensions of the product can be derived from a central table. Since the same products are frequently distributed in packages of different sizes, this table is not necessarily error-free. It is therefore also advantageous if the input station is provided with a measuring device that detects at least one critical dimension of the product. Deviations between the size according to the table and the actual size can thereby be determined. Occasionally there are also deviations with respect to the filling level, for which reason it is additionally desirable to provide a scale.

The measuring device can also detect all geometric values if it is considered likely that each of the individual values can deviate from the value determined from the table. The dimensions are detected in the simplest case with ultrasound distance sensors for which a reference edge can be provided, against which the inputting person must place the product to be stored, to reduce the required number of distance measurements. Without these reference edges against which the product is to be placed, the number of required ultrasound sensors is increased depending upon which incorrect orientations are permitted.

If reference edges are used it is necessary to ensure that the product is placed properly against the reference edges. For this purpose, a photoelectric sensor can be used, preferably in the form of a reflector light sensor using a reflector arranged in the inside corner area between the two reference edges. If no light strikes this reflector light sensor, the product is properly positioned; if light does strike it, however, either no product has been put in place or the product is out of position with respect to the reference edges.

The expense for the transport device that moves the products from the input station to the appropriate storage row on the interim storage shelf is reduced if the input station has a lifting table that is movable vertically. The otherwise necessary vertical adjustability of the transport device, which would necessitate a larger constructive and apparatus expense, is thereby eliminated.

To enable storing cylindrical products as well if desired, the lifting table can be provided with parallel flutes or grooves one alongside the other. These flutes or grooves are oriented parallel to the longitudinal direction of the storage rows.

Corresponding to this design of the lifting table, the interim storage shelf can also contain a strip shaped area in which these flutes are provided so that roll-off of a cylindrical object is prevented. In the area in which the products are moved to the storage row, however, the interim storage shelf is flat, to prevent noise when products are moved on the interim storage shelf.

The transport device may be constructed in the manner of a gripper or tongs with two jaws, at least one of which can be moved towards the other. By using two jaws movable relative to one another, it is also possible to use the distance between the jaws when a product is gripped as a measuring device, in order to render a separate measurement head superfluous.

The mobility of the jaws relative to one another also ensures that the product does not get wedged during introduction into the storage row on the interim storage shelf, and does not collide with other products already waiting there. The products can be held frictionally between the jaws, which improves the transport process. On the other hand it is also possible to provide stops on the side of the jaws opposite the delivery edge in order to move the products with positive engagement onto the shelf control appliance during delivery from the interim storage shelf.

A novel method for storing products can also be implemented with the novel shelf storage arrangement. According to the novel method, the product is identified at the input station and then input into an interim storage area. The product is brought to the final storage site from the interim storage area via the shelf control appliance, which is present in any case. This transfer from the interim storage area, which serves as a buffer, into the final storage space takes place whenever the shelf control appliance is not needed for retrieval processes. All retrieval processes are first handled by the shelf control appliance before the shelf control appliance is called upon to transfer products from the buffer area to the final storage area. Thereby the storage expense is considerably reduced, since the apparatus that serves the interim storage shelf is considerably simpler and practically must be moved in only two dimensions, rather than in three dimensions. Moreover, the transport device which supplies the interim storage shelf for placement into storage is moved spatially in a different place from that of the motion of the shelf control appliance that retrieves products from the interim storage shelf and stores them in the storage shelf so that spatial collision does not take place. Storage and retrieval are thus temporally separated from one another, whereby the intervals between retrieval processes can be used to bring products from the buffer area, i.e., from the interim storage shelf, to the final storage position.

Other objects and advantages of the invention will become apparent upon reading the following detailed description and upon reference to the drawings, in which:

### BRIEF DESCRIPTION OF THE DRAWINGS

FIG. 1 is a diagrammatic perspective of a shelf storage system in accordance with the invention;

FIG. 2 is a perspective of an interim storage shelf and transport device for the illustrated shelf storage system, shown in a first functional position; and

FIGS. 3-7 are further simplified perspectives illustrating the functional operation of the storage system.

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DESCRIPTION OF THE PREFERRED EMBODIMENTS

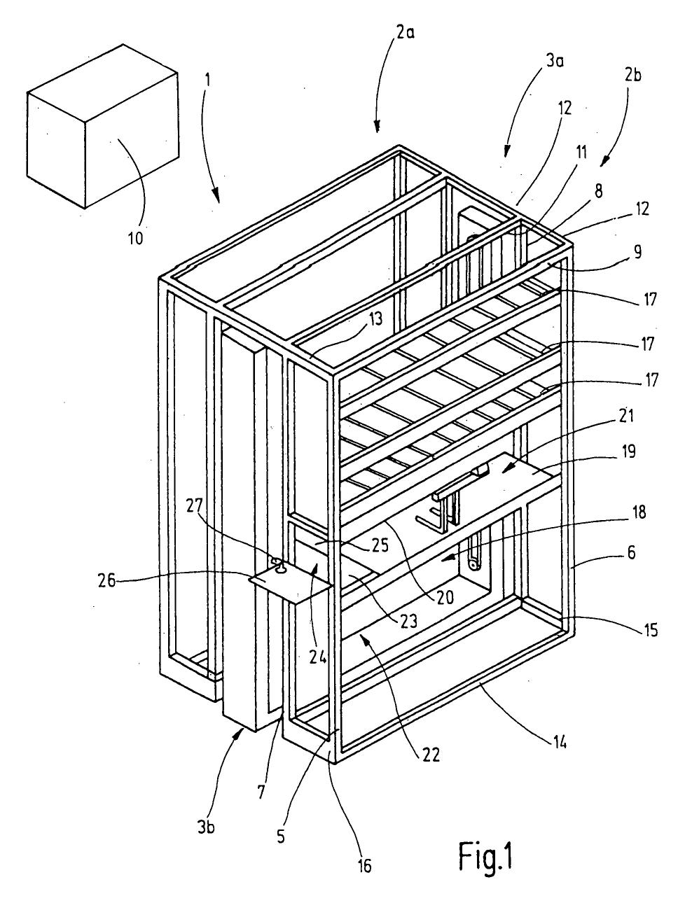

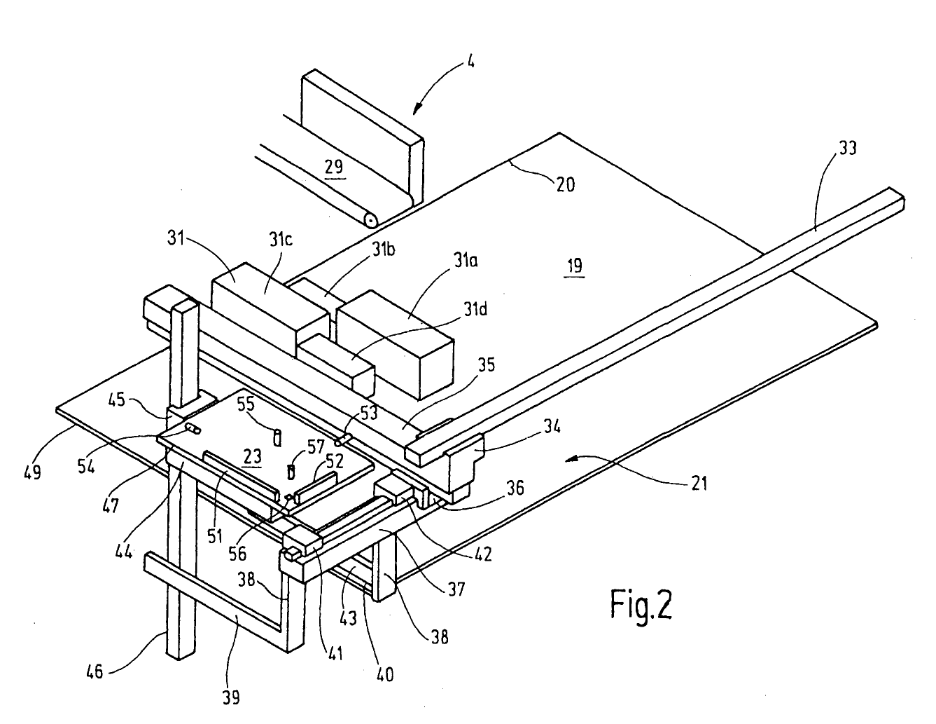

Referring now more particularly to FIG. 1 of the drawings, there is shown an illustrative shelf storage system 1 in accordance with the invention, which by way of example, has particular utility in pharmacies for storing packaged and unpackaged medicines that have a relatively short turnaround time. The products are chaotically stored in shelf system 1, with records being kept of where each medicine is stored in a computer system 10, as will become apparent. The illustrated shelf storage system 1 comprises two opposing shelf frames 2a, 2b, which face one another with their along their broad sides and are connected to one another at opposite ends. Two vertical posts 3a, 3b between which a crossbeam is vertically movable, as will be seen, are disposed in parallel relation to each other in the intermediate space between shelf frames 2a, 2b. A shelf control appliance 4, schematically shown in FIG. 2, runs along the crossbeam and can be brought into any position in front of the broad side of the respective shelf frame 2a, 2b.

Shelf frames 2a, 2b, which can be made of profile structural members or tubes, include vertically projecting posts 5, 6, 7, 8, which are connected at the upper end by bars 9, 11, 12, and 13. They are connected at the lower end of the vertical posts by bars 14, 15 and 16, with bar running parallel to bar 14 not labeled in the figure. Shelf frame 2a is constructed in the same manner with the same dimensions, for which reason a repeated explanation is superfluous. The reference numbers are not repeated on shelf frame 2a.

The shelf frame 2b includes a plurality of rectangular primary storage shelves 17 arranged one above the other, each having in the direction facing the shelf control appliance 4, a straight edge, which is referred to herein as the output edge. Each shelf 17 extends from posts 5, 7 at one end to posts 6, 8 on the other end and projects slightly past posts 7, 8 in the direction of the passageway formed between shelf frames 2a, 2b. It will be understood that the shelves in the shelf frame 2a are omitted from FIG. 1 for reasons of clarity. The distances between shelves 17 are different, with the height distribution being adapted for the expected spectrum of packages to be stored for enabling housing of products most space-effectively.

Only shelf frame 2b contains an arrangement, labeled 18 as a whole, for storing products in the shelf storage system 1. This arrangement 18 comprises an interim storage shelf 19 that extends parallel to shelves 17 and coincides roughly with them. In the direction facing the passageway having shelf control appliance 4, the interim storage shelf 19 has a straight output edge 20 that lies in a common vertical plane with the output edges of shelves 17. Above interim storage shelf 19 is provided a transport device 21 for moving products to be stored on the upper side of interim storage shelf 19.

On the left narrow side of interim storage shelf 19, as viewed in FIG. 1, there is an input station labeled 22 as a whole, comprising a lifting table 23 that can be lowered into a recess into a corresponding opening next to interim storage shelf 19. The lifting table 23 is accessible via an input opening 24 provided in the narrow side between posts 5, 7. The input opening 24 can be closed by means of a motor-driven sliding door 25. A holding table 26, on which stands a barcode scanner 27, is mounted in front of input opening 24.

FIG. 2 shows the individual elements that are necessary for storing products, again in an enlarged and substantially simplified perspective representation, wherein all structural elements that are not important for an understanding of the invention have been omitted for purposes of clarity. The interim storage shelf 19 with its straight output edge 20 can be seen in FIG. 2. The shelf control appliance 4, which is provided with a conveyor belt 29 that can transport product 31 perpendicular to output edge 20, runs in front of the output edge. Above interim storage shelf 19 is situated the transport device 21, which includes a guide rail 33 rigidly mounted in shelf frame 2b. Guide rail 33 extends across the entire width of shelf frame 2b and is fastened to the side remote from output edge 20. Guide rail 33 is sufficiently far away from the support surface of interim storage shelf 19 that the highest product 31 to be stored can be handled.

Running along the guide rail 33 is a suspended guide slide 34 and a guide rail 35 projecting from guide slide 34. Guide rail 35 extends perpendicular to output edge 20. A slide 36 runs on the guide rail 35, from which a guide rail 37 parallel to guide rail 33 projects to lifting table 23.

The slide 36 together with guide rail 37 can be moved with the aid of the guide rail 35 towards output edge 20 or away from it. The height of guide rail 37 above interim storage shelf 19 is determined by the vertical dimension of the largest package to be stored as will become apparent.

Two gripping jaws 39, 40 that are connected via bars 38 to associated guide slides 41, 42, respectively, are guided by means of guide rail 37 for movement along the guide rail 37. Gripping jaws 39, 40 are arranged suspended and form opposing and mutually parallel flat gripping surfaces, of which only gripping surface 43 of gripping jaw 40 can be seen.

All the guide slides 34, 36, 41 and 42 can be moved along the associated guide rail in a known manner by linear drives, for instance, motor-driven threaded spindles. The motors are controlled via a central computer controller of the computer system 10, which knows the position of guide slides 34, 36, 41 and 42 along with their associated guide rail by means of appropriate positive feedback mechanisms known in the art so that the program for storage can be executed.

Lifting table 23 also serves as the weighing table for a scale 44 mounted on a guide slide 45. Guide slide 45 runs vertically along a guide post 46 and can be moved from a raised position, in which it is flush with the flat surface of holding table 26, to a lowered position, in which the supporting surface of lifting table 23 is flush with the flat upper surface of interim storage shelf 19.

Lifting table 23 is rectangular and in the raised position its side edge 47 borders the adjacent side edge of holding table 26 with a slight gap, while in the lowered position its opposite side edge 48 borders an adjacent side edge 49 of interim storage shelf 19 with a slight gap. Lifting table 23 therefore acts as an elevator to move products from the level of holding table 26 to the level of interim storage shelf 19. Two mutually parallel contact strips are provided in framework 2b above lifting table 23. Contact strip 51 is adjacent to side edge 47, while contact strip 52 is situated on the side closest to guide rail 33. Contact strips 51, 52 are stationary and do not move back and forth with lifting table 23. In the lowered position, lifting table 23 forms an absolutely flat surface for transport device 21.

In order for product 31 to be assigned to the correct storage row in shelf storage system 1, a measurement device is provided comprising three measuring heads 53, 54, 55 operating on an ultrasound basis that are fixed with respect to the frame. Measuring head 53 measures in the direction towards contact strip 51, measuring head 54 in the direction towards contact strip 52, and measuring head 55 in the direction towards the upper surface of lifting table 23. In this way the length, width and height of a rectangular package can be detected. Thus it is also possible to assure that the operator places product 31 with the largest side surface onto lifting table 23 in order to eliminate any instability in the subsequent movement processes. Furthermore, storage space is saved in this way.

The measurement device in the form of ultrasound measuring heads 53, 54, 55 would supply erroneous measurements if product 31 were not positioned precisely against stop strips 51, 52. In case of an incorrect orientation, an opening would remain in the inner corner defined by the stop surfaces of the two stop strips 51, 52. This effect is detected by a reflector photoelectric sensor comprising a reflector 56 on lifting table 23 and a measuring head 57 fixed with respect to the framework. Measuring head 57 transmits visible or invisible light in the direction of reflector 56, which is reflected there and detected by a photodiode in measuring head 57. Reflector 56 is situated directly in the inner corner defined by the contact surfaces facing away from the observer of the two stop strips 51, 52, i.e., towards the center of the table. The diameter of the effective light beam is roughly 2 mm, so that even slightly incorrect orientations are measured.

Both ultrasound measuring heads 53, 54, 55 and measuring head 57 of the reflector photoelectric sensor are connected to the above-mentioned computer controller in order to determine the necessary data and compare it to predetermined parameters. If it is determined that the product was not properly inserted, a corresponding error message is issued to the user, but storing is otherwise not initiated.

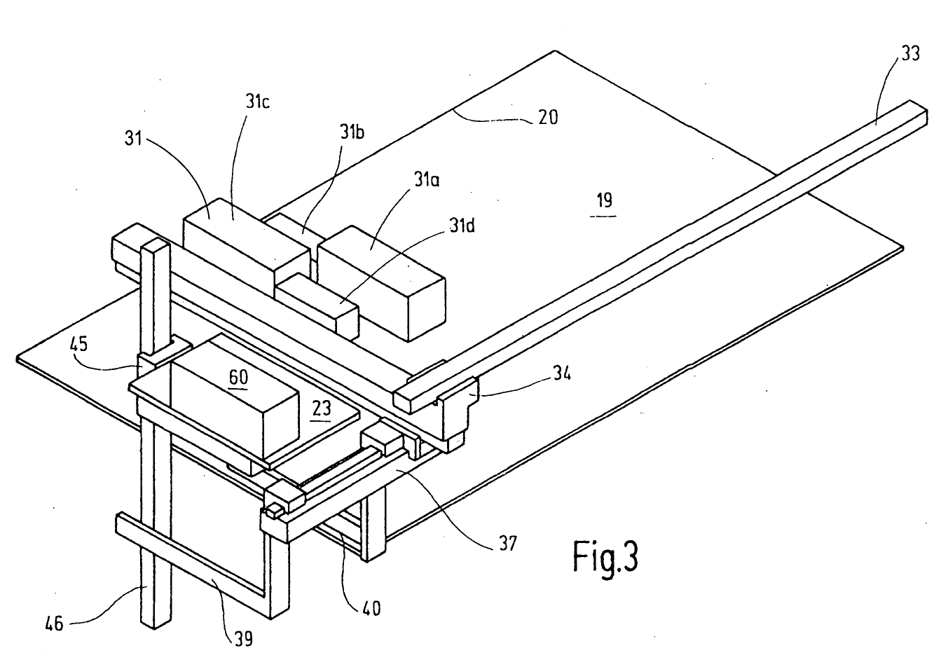

The mode of operation of the apparatus will now be explained with reference to FIGS. 3-8. For reasons of clarity, shelf control appliance 4, fixed ultrasound measuring heads 53, 54, 55, fixed stop strips 51, 52, as well as fixed measuring head 57, are omitted in these figures for purposes of clarity.

Let it be assumed as a starting point that several products 31a, 31b, 31c, 31d have already been stored according to the method described below. Products 31d and 31c form a virtual storage row oriented perpendicular to output edge 20. Alongside it, the two products 31b, 31a likewise form a virtual storage row, separated by a gap that is at least as large as the thickness of gripping jaw 39, 40. Products or packages with quite different sizes can be waiting in one and the same storage row as long as their cross-sectional surface perpendicular to the supporting surface of interim storage shelf 19 is greater than a predetermined minimal window, but smaller than a predetermined maximal window.

In a manner known to a person skilled in the art, the tolerance window defined in this way results in maximal exploitation of the theoretical storage capacity, flexibility, and secure transport when products are moved onto shelf 17. The size of the tolerance window is not subject matter of the invention and therefore need not be further defined in detail here.

In order to input an additional product 60, the user first holds the product or package 60 under barcode reader 27 so that the central computer management of shelf storage system 1 obtains knowledge of what product is to be stored. Based on a stored table, the controller knows what size of package is to be expected for the product labeled in this manner.

After the barcode is read, the controller opens sliding door 25 and the user can place product 60 properly onto lifting table 23, depicted in FIG. 3, with the aid of, and monitored by, the measuring device using the measuring heads and their reflector photoelectric sensor as well as the stop strips.

The correct placement, i.e. non-tilted contact, against stop strips 51, 52 is checked, the dimensions of package 60 are verified by ultrasound measuring heads 53, 54 and 55, and it is checked whether package 60 is lying on its largest flat side. Additionally, the weight of product 60 is detected with the aid of scale 44 in order to determine whether this is a properly filled package. If it is determined that values agree with the values in the table or the control values, the sliding door 25 is closed by electric motor power. It will be understood that appropriate monitoring devices can be provided on the sliding door 26 to prevent pinching or crushing of the hands.

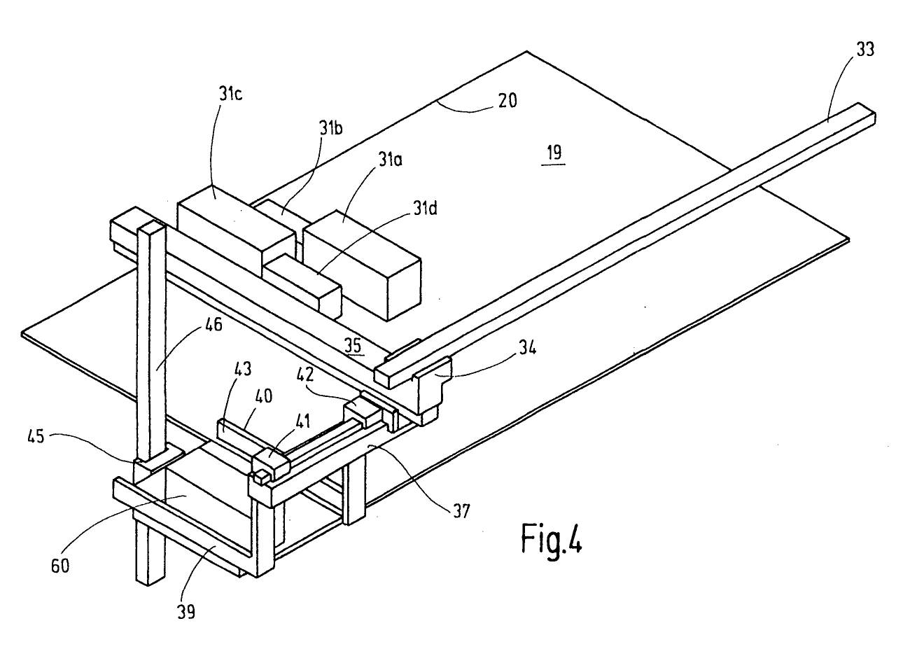

As soon as sliding door 25 is closed, the lifting table 23 is moved from the raised position shown in FIG. 3 to the lower position shown in FIG. 4. Before lifting table 23 is lowered, gripping jaws 39, 40 are moved into the position according to FIGS. 2 and 3 with their gripping surfaces 43 spaces apart in the direction parallel to output edge 20.

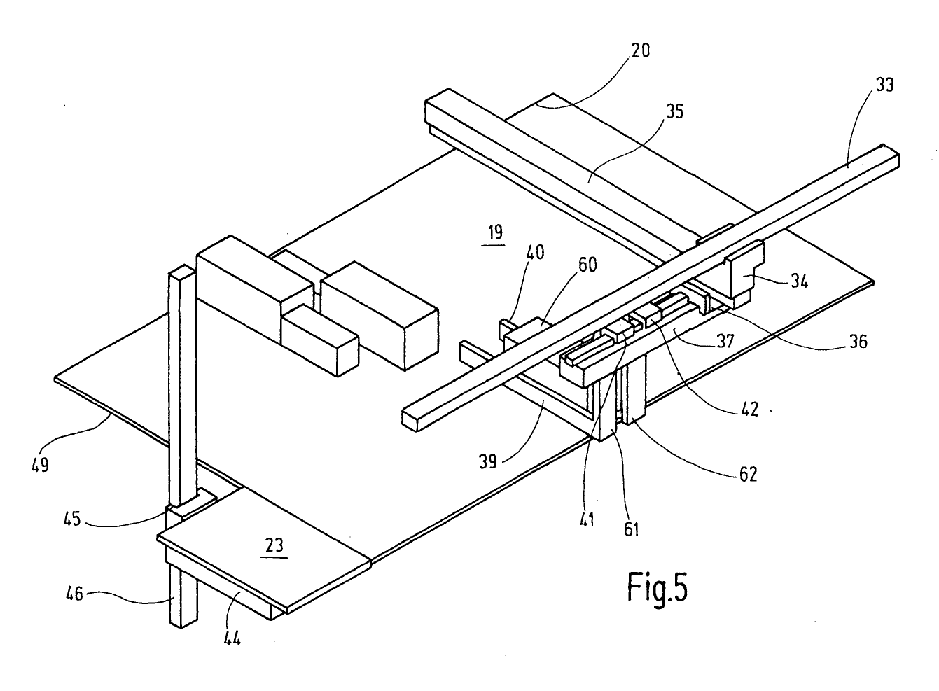

Lifting table 23 is moved vertically downwards along guide post 46 between the two gripping jaws 39, 40 until its supporting surface is in the plane of the supporting surface of interim storage shelf 19, as shown in FIG. 4. Then the two gripping jaws 39, 40 are moved towards one another until the distance between them corresponds to the width of the product as was previously measured immediately after input. Package 60 or the product is now held substantially without any play between the two gripping jaws 39, 40, but without any pressure. Now the two gripping jaws 39, 40 are moved into the position according to FIG. 5, wherein they push the product 60 held by them off of the surface of lifting table 23 and onto the surface of interim storage shelf 19. They move the product 60 further along to the next free virtual storage row alongside the already waiting products 31a, 31b.

As is evident from the representation in FIG. 5, the length of gripping jaws 39, 40 is dimensioned such that on the one hand the longest package 60 to be expected can be displaced perpendicular to its longitudinal extent without twisting, and on the other, enough space still remains free on interim storage shelf 19 to form a sufficiently long storage row for products 31 waiting there.

As soon as the correct position according to FIG. 5 is reached, product 60 is pushed with the aid of gripping jaws 39, 40 into the new virtual storage row in the direction towards output edge 20. The two gripping jaws 39, 40 prevent sideways tilting. The necessary thrust force is transferred to product 60 by stops 62 that are provided at the end of the two gripping jaws 39, 40 furthest removed from output edge 20.

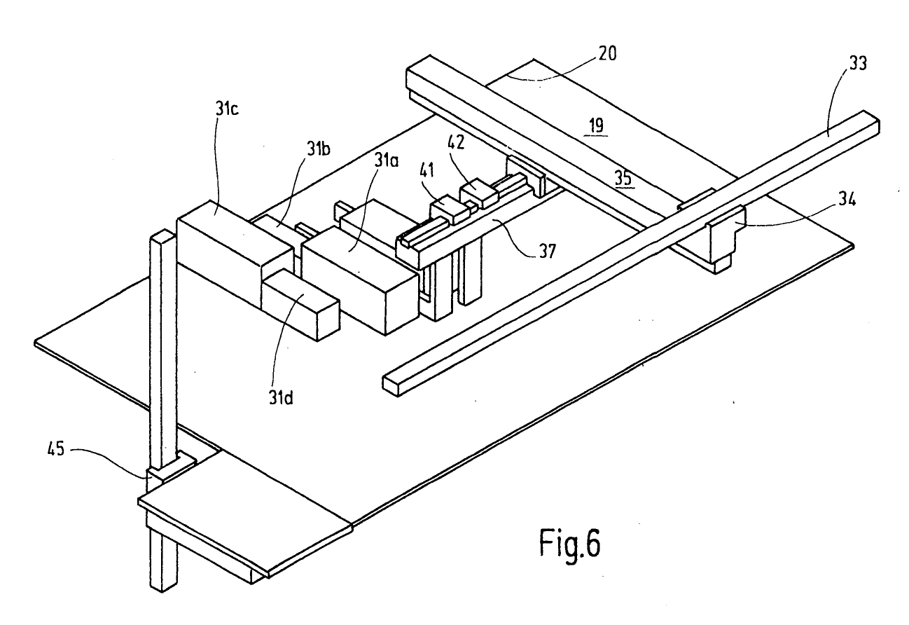

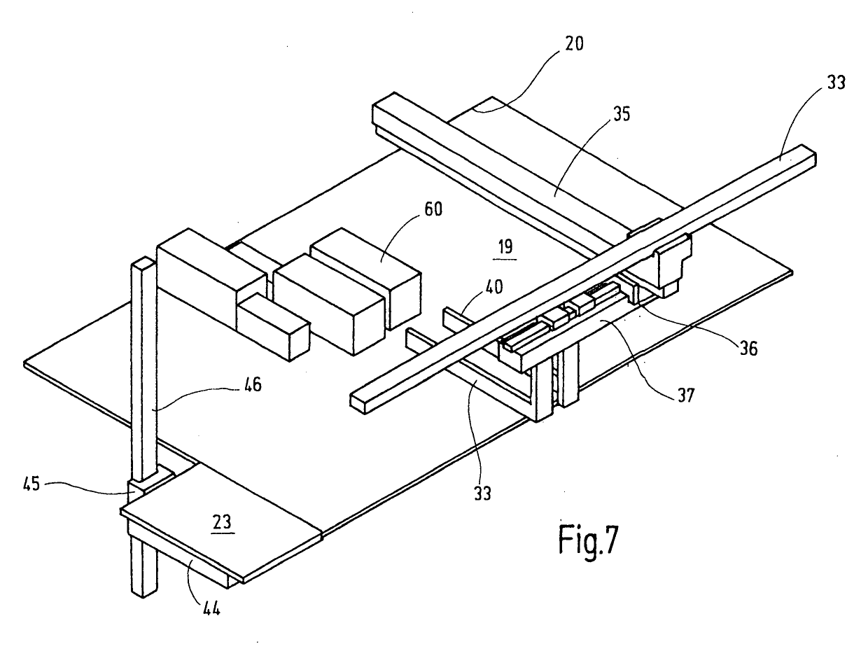

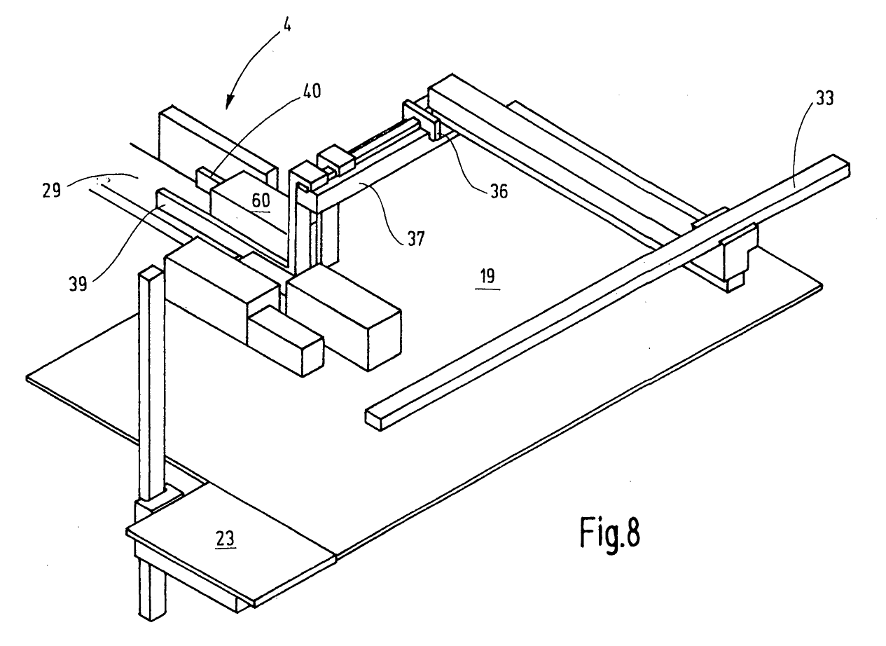

The final position after product 60 has been pushed forward into the final position in the virtual storage row is shown in FIG. 6. Thereafter the two gripping jaws 39, 40 open slightly and move back according to FIG. 7 to the rear edge of interim storage shelf 19, until the free ends of the two gripping jaws 39, 40 can be moved, collision-free behind the stored products 60 or 31a-31d, parallel to the output edge.

With the aid of the arrangement of interim storage shelf 19 and transport device 21 as shown, objects to be stored in shelf storage system 1 that have been brought in via lifting table 23 can be interim-stored. Moving away from interim storage shelf 19 to the final storage places in the shelf storage system is carried out with the aid of shelf control appliance 4. This shifting process takes place as soon as all pending orders for retrieval of products have been handled by shelf control appliance 4. Shelf control appliance 4 is then employed to transfer objects 31a-31d or 60 parked on interim storage shelf 19 from interim storage shelf 19 into the ultimate storage sites. For this purpose the gripping device according to FIG. 8 with the appropriately adjusted gripping jaws 39, 40 moves up to the virtual storage row in which the product to be stored, for instance product 60, is situated. With the aid of gripping jaws 39, 40 and stops 61, 62 provided at the end of the gripping jaws, product 60 is pushed across output edge 20 onto transport belt 29 of shelf control appliance 4. Transport belt 29 accepts product 60 and ultimately conveys it completely onto shelf control appliance 4. Control appliance 4 then moves in a known manner to the desired storage place and outputs product 60 onto the shelf there.

The storing and retrieval of products with the aid of shelf control appliance 4 is largely decoupled temporally with the aid of arrangement 18 so that the retrieval processes can be handled one after the other with first priority, while storage in the intervals between the retrieval processes takes place with lower priority. Due to the interim parking on interim storage shelf 19, the inputting person can operate largely continuously without being significantly hampered by the retrieval processes. Because of the verbal sales interaction in the store, the retrieval processes are separated from one another by wide time intervals compared to the speed with which a pharmacy assistant can input the products into shelf storage system 1.

A number of variations of apparatus 18 as described are possible. For instance ultrasound 53 can be eliminated if the two gripping jaws 39, 40 are used for measuring the dimension of the product in this direction. It is also conceivable to provide the supporting surface of lifting table 23 with flutes running parallel to front edge 47 and thus perpendicular to output edge 20. Cylindrical objects can be securely held on lifting table 23 with the aid of these grooves. The strip-shaped area in which the virtual storage rows are present on interim storage shelf 19 can likewise be furnished with corresponding flutes, while the strip-shaped area between the rear end of the virtual storage rows and the rear edge of interim storage shelf 19 that runs parallel to output edge 20 is still smooth. Sounds from the displacement of products in the direction parallel to output edge 20 are avoided, while cylindrical objects can be precisely positioned.

From the foregoing, it can be seen that the shelf storage system is furnished with an interim storage shelf. The interim storage shelf, which is inserted into the group of shelves, is approached by the shelf control appliance in order to accept products. Products are always stored via the interim storage shelf, with the aid of a transport device. Because of the use of the interim storage shelf, the product can be parked until the shelf control appliance has handled the output processes. Moreover, a second shelf control unit is not required in order to distribute the products in this shelf for the purpose of storage.

1-42. (canceled)

43. A shelf storage arrangement (1), particularly adapted for a pharmacy shelf storage system, comprising
a frame (2),
at least one primary storage shelf (17) supported by said frame (2) having an output edge (20) running in a longitudinal direction of the shelf on which products (31, 60) can be stored in rows oriented perpendicular to the output edge (20) and from which products can be removed during retrieval in a direction perpendicular to the output edge (20,
a shelf control appliance (4) movable back and forth in front of the output edge (20) of the at least one primary storage shelf (17),
an input station (22) into which products (31, 60) to be stored can be input,
a measuring device (53, 54, 55, 57) for detecting at least one geometric value of products (31, 60) to be stored,
an interim storage shelf (19) for interim storage of products (31, 60), said interim storage shelf (19) having has an output edge (20) running in a longitudinal direction of the interim storage shelf (19) across which the products are moved when being output from interim storage shelf (19) and to which the shelf control appliance can be moved, and
at least transport device (21) for transporting products (31, 60) from input station (22) to interim storage shelf (19) and for moving products from interim storage shelf (19) to the shelf control appliance (4).

44. The shelf storage arrangement of claim 43 including a plurality of said primary storage shelves (17), said primary storage shelves being disposed one above another oriented such that their output edges lie in a common vertical plane.

45. The shelf storage arrangement of claim 44 in which said primary storage shelves (17) contains the interim storage shelf (19) with the output edge of the interim storage shelf lying in the plane of the output edges of said plurality of shelves.

46. The shelf storage arrangement of claim 43 in which said interim storage shelf (19) lies a distance away from said plurality of primary storage shelves (17) with the output edge (20) of interim storage shelf (19) oriented towards the plane of the output edges of the primary storage shelves (17).

47. The shelf storage arrangement of claim 43 including two groups of said primary storage shelves (17) wherein the output edges (20) of one group face the output edges (20) of the other group, and one of said groups of storage shelves (17) contain said interim storage shelf (19) with the output edge (20) of the interim storage lying in the same plane as the output edges of the shelves of the one group.

48. The shelf storage arrangement of claim 43 in which said interim storage shelf (19) has a length along its output edge (20) which is no greater than the length of the output edge of the at least one primary storage shelf.

49. The shelf storage arrangement of claim 43 in which said interim storage shelf has a depth corresponding to a depth of the at least one primary storage shelf.

50. The shelf storage arrangement of claim 43 in which said shelf control appliance (4) has a transport device (29) operable for moving a product (31) perpendicular to the output edge of the interim storage shelf.

51. The shelf storage arrangement of claim 43 including a measurement device (53, 54, 55, 57) disposed at the input station (22).

52. The shelf storage arrangement of claim 43 including a barcode reader (27) disposed at the input station (22).

53. The shelf storage arrangement of claim 43 in which said input station has an input opening with a motor-driven door (25) that is movable between open and closed positions.

54. The shelf storage arrangement of claim 51 in which said measurement device (53, 54, 55, 57) includes an ultrasound measuring head for detecting the geometric value of products.

55. The shelf storage arrangement of claim 51 in which said measurement device (53, 54, 55, 57) is operable for measuring the length, width, and height of a product (31, 60).

56. The shelf storage arrangement of claim 54 in which said measuring device has at least two said ultrasound measuring heads.

57. The shelf storage arrangement of claim 54 in which said measuring device has at least three ultrasound measuring heads.

58. The shelf storage arrangement of claim 51 in which said measuring device (53, 54, 55, 57) includes a first transport device (21).

59. The shelf storage arrangement of claim 51 in which said measuring device (53, 54, 55, 57) has two reference edges (51, 52) oriented and in perpendicular relation to each other.

60. The shelf storage arrangement of claim 59 including a testing device (57) associated with said measuring device (53, 54, 55, 57) for determining whether the product is properly placed with respect to the reference edges (51, 52).

61. The shelf storage arrangement of claim 60 in which said testing device is a photoelectric sensor.

62. The shelf storage arrangement of claim 61 in which said photoelectric sensor is a reflective light sensor having a reflector provided on a supporting surface (23) onto which input product (31, 60) is placed.

63. The shelf storage arrangement of claim 43 in which said input station includes a scale (44).

64. The shelf storage arrangement of claim 43 in which said input station (22) includes a holding table (23).

65. The shelf storage arrangement of claim 64 in which said holding table is vertically movable.

66. The shelf storage arrangement of claim 43 including a measurement device (53,54,55,57) having at least one reference edge (51,52), and a holding table having grooves parallel to one another and to the at least one reference edge (51) of the measurement device.

67. The shelf storage arrangement of claim 65 in which said holding table is vertically movable from a first position in which the holding table is flush with a supporting surface of the interim storage shelf (19) to a second position in which the interim holding table (23) is positioned for receiving product (31, 60) through an input opening (24) of the input station (22).

68. The shelf storage arrangement of claim 43 in which said interim storage shelf (19) has a strip-shaped area extending over the length of interim storage shelf (19) provided with parallel grooves equidistant from one another, said strip-shaped area having a width measured in the direction of the depth of interim storage shelf (19) that is smaller than the depth of interim storage shelf (19), and said interim storage shelf (19), apart from said grooves, is otherwise smooth and flat.

69. The shelf storage arrangement of claim 43 in which said interim storage shelf (19) is smooth and flat over the entire depth and length.

70. The shelf storage system of claim 43 in which a single said transport device (21) is operable for transporting products from the input station (22) to the interim storage shelf (19) and for moving products from the interim storage shelf (19) to the shelf control appliance (4).

71. The shelf storage arrangement of claim 43 in which said transport device (21) has a gripping device (39, 40).

72. The shelf storage arrangement of claim 71 in which said gripping device (39, 40) is movable along a guide rail (34) in the direction parallel to output edge (20) of interim storage shelf (19).

73. The shelf storage arrangement of claim 71 in which said gripping device (39, 40) has two gripping jaws, at least one of which is movable toward the other jaw (39, 40).

74. The shelf storage arrangement of claim 73 in which said jaws (39, 40) have contact services (43) that are oriented perpendicular to output edge (20) of the interim storage shelf.

75. The shelf storage arrangement of claim 74 in which said jaws (39, 40) are jointly movable in the direction perpendicular to output edge (20) in the interim storage shelf.

76. The shelf storage arrangement of claim 75 in which said gripping devices (39, 40) are jointly movable in a direction parallel to the output edge (20) of the interim storage shelf.

77. The shelf storage arrangement of claim 75 in which said gripping device (39, 40) has a stop (61, 62) at its end remote from output edge (20) of the interim storage shelf.

78. A method for storing products (31, 60) in a shelf storage system with chaotic storage comprising the steps of:
placing a product (31, 60) by the input station (22) to be stored in an input station (22),
measuring at least one geometric dimension of the product (31, 60),
transferring the product (31, 60) to an interim storage shelf (19),
transferring the product from the interim storage shelf (19) to a shelf control appliance (4), and
transferring the product from the shelf control appliance (4) to a free storage space on a primary storage shelf (17) of a shelving arrangement for purposes of storage.

79. The method according to claim 78 including retrieving product (31, 60) from the primary storage shelf in response to an order, and transferring product (31, 60) from the interim storage shelf to the primary storage shelf whenever orders for retrieval of product (31,60) from the primary storage shelf (17) by the shelf control appliance have been satisfied.

80. The method of claim 78 including first moving products (31, 60) on the interim storage shelf in a longitudinal direction of the interim storage shelf and then moving the products (31, 60) into position closer to an output edge of the interim storage shelf.

81. The method of claim 78 including positioning and storing a plurality of products (31, 60) on the interim storage shelf (19) with the products arranged in rows that run perpendicular to an elongated output edge of the interim storage shelf (19).

82. The method of claim 81 in which more than one product can be stored in each said row.

83. The method of claim 82 in which the dimensions of products stored in each row are selected to match a predetermined toleranced window size.

84. The method of claim 83 in which said predetermined toleranced window size is defined by the height and/or weight of the product and is matched to the row on the primary storage shelf (17) an which products are ultimately stored.
